(19) United States
(12) Patent Application Publication
(10) Pub. No.: US 2026/0039476 A1
(43) Pub. Date: Feb. 5, 2026

(54) DISTRIBUTED COMPUTER SYSTEM AND METHOD FOR MANAGING AND RECORDING FUNCTIONALITIES OF AUTONOMOUS AGENTS

(71) Applicant: ASSMBL.AI LIMITED, Bury St Edmunds (GB)

(72) Inventors: Humayun Munir Sheikh, Bury St Edmunds (GB); Attila Bagoly, Bury St Edmunds (GB)

(21) Appl. No.: 19/351,273

(22) Filed: Oct. 6, 2025

Related U.S. Application Data
(63) Continuation-in-part of application No. 18/483,515, filed on Oct. 9, 2023, now Pat. No. 12,462,295.
Application No. 18/483,515 is a continuation-in-part of application No. 18/318,897, filed on May 17, 2023.

(51) Int. Cl. H04L 9/32; H04L 9/00

(52) U.S. Cl. CPC H04L 9/3236; H04L 9/50

(57) ABSTRACT

The present disclosure provides a distributed computer system that includes worker nodes that are coupled together via a data communication network to exchange data therebetween, where the worker nodes include computing arrangements and local databases to process and store data therein. The worker nodes are autonomous agents (AAs), where the distributed computer system is configured to use the worker nodes for fulfilling a service request. The distributed computer system also includes a processing arrangement that generates a capability mapping structure comprising one or more data elements, where each data element represents a functionality of an autonomous agent of the plurality of autonomous agents.

### CROSS-REFERENCE TO RELATED APPLICATIONS

This application is a continuation-in-part of U.S. patent application Ser. No. 18/483,515, titled “DISTRIBUTED COMPUTER SYSTEM AND METHOD ENABLING APPLICATION OF AUTONOMOUS AGENTS” and filed on Oct. 9, 2023, which is incorporated herein by reference.

### TECHNICAL FIELD

The present disclosure relates to distributed computer systems. Moreover, the present disclosure relates to methods of operating the distributed computer systems.

### BACKGROUND

The field of distributed computing has undergone remarkable transformations in recent years, driven by the ever-increasing demand for efficient and scalable systems capable of handling complex service requests. With the advent of cloud computing, Internet of Things (IoT), and the proliferation of data-driven applications, the expectations from the distributed computing have reached unprecedented levels. Whether it's the real-time processing of massive datasets, the management of autonomous devices, or the delivery of on-demand services, the distributed computing landscape is under constant pressure to deliver on said demands.

Existing systems make use of search and discovery databases to identify and deploy the autonomous agents for fulfilling service requests of users. However, the existing systems fail to fulfil the escalating demand for storage space. Additionally, expanding memory to the autonomous agents, translates into heightened hardware costs for the existing systems.

Moreover, existing known techniques for searching and managing the functionality of each autonomous agent suffer from time inefficiencies, resulting in reduced system responsiveness. There exist some systems that use probabilistic data structures (such as bloom filters) for searching and managing the functionality of each autonomous agent. However, such probabilistic data structure consists of hash functions that occasionally map different autonomous agents' functionalities to a common location (referred to as a hash collision), leading to the generation of false positives.

Furthermore, different distributed computing environments may require different approaches to capability management depending on factors such as network topology, agent population size, update frequency, and accuracy requirements. While some systems may benefit from tree-based cryptographic structures providing hierarchical organization, others may require probabilistic data structures optimized for specific query patterns, hash table-based structures for deterministic lookups, or graph-based representations that capture capability relationships. Additionally, the nature of task generation has evolved with advances in artificial intelligence, including large language models, transformer architectures, and generative AI systems.

Therefore, in light of the foregoing discussion, there exists a need for a flexible distributed computer system architecture that can employ various capability mapping structures suited to different operational requirements while maintaining efficient agent discovery, cryptographic verification, and space-efficient storage of agent functionalities.

### SUMMARY

The aim of the present disclosure is to provide a distributed computer system and a method to efficiently manage and record the functionalities of autonomous agents while mitigating growing storage demands thereof. The distributed computer system employs a capability mapping structure that can be implemented using various data structures optimized for different operational requirements. The capability mapping structure stores cryptographic representations of agent functionalities in a space-efficient manner, enables deterministic or probabilistic lookup of agent capabilities, and performs cryptographic verification of agent functionality presence or absence.

In various embodiments, the capability mapping structure may be implemented as: (i) tree-based data structures comprising cryptographic hash values organized in hierarchical arrangements, including bloom trees that combine invertible bloom filters with Merkle tree structures, or Merkle trees with leaf nodes representing functionality hashes; (ii) probabilistic data structures comprising bit arrays for efficient representation, including cuckoo filters, count-min sketches, or quotient filters; (iii) hash table-based data structures comprising key-value pairs, including distributed hash tables implementing consistent hashing protocols; or (iv) graph-based data structures comprising nodes representing agent capabilities and edges representing capability relationships.

The system further employs language models, which may include machine-learning models, large language models (LLMs), transformer-based models, neural networks, or generative AI models, to analyze service request objectives and generate corresponding tasks for autonomous agent execution.

The aim of the present disclosure is achieved by a distributed computer system and a method of operating the distributed computer system as defined in the appended independent claims to which reference is made to. Advantageous features are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 is an illustration of a distributed computer system, in accordance with an embodiment of the present disclosure; and

FIGS. 2A and 2B is an illustration of a flowchart illustrating steps of a method of operating a distributed computer system, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In a first aspect, the present disclosure provides a distributed computer system for managing and recording functionalities of a plurality of autonomous agents, the system comprising:
a plurality of worker nodes that are coupled together via a data communication network to exchange data therebetween, wherein the plurality of worker nodes include computing arrangements and local databases to process and store data therein, wherein the plurality of worker nodes are the plurality of autonomous agents (AAs), and wherein the distributed computer system is configured to use the plurality of worker nodes for fulfilling a service request;
a processing arrangement configured to generate a capability mapping structure comprising one or more data elements, wherein each data element represents a functionality of an autonomous agent of the plurality of autonomous agents, and wherein the capability mapping structure is configured to:
   store cryptographic representations of agent functionalities in a space-efficient manner;
   enable deterministic or probabilistic lookup of agent capabilities; and
   perform cryptographic verification of agent functionality presence or absence; and
a software framework, wherein the software framework comprises:
   a client-agent device configured to:
      receive the service request;
      generate an objective associated with the service request; and
      send the objective to at least one autonomous agent of the plurality of autonomous agents, and
   at least one language model comprised in the at least one of the autonomous agents of the plurality of autonomous agents, wherein the at least one language model is configured to:
      receive the objective from the at least one autonomous agent of the plurality of autonomous agents;
      generate tasks related to the objective received from the at least one autonomous agent of the plurality of autonomous agents; and
      send the generated tasks to the at least one autonomous agent of the plurality of autonomous agents,
wherein the at least one autonomous agent of the plurality of autonomous agents is configured to:
   execute a pre-processing operation to generate a plurality of proof values corresponding to the tasks using the capability mapping structure and to send the plurality of proof values to the processing arrangement;
   execute instructions to configure the processing arrangement to identify a list of associated autonomous agents of the plurality of autonomous agents by mapping a given proof value to the capability mapping structure; and
   receive from the processing arrangement the list of associated autonomous agents of the plurality of autonomous agents,
wherein the associated autonomous agents of the plurality of autonomous agents are configured to perform the tasks required to fulfill the service request by executing at least one action.

The first aspect of the invention introduces the distributed computer system comprising the plurality of autonomous agents (AAs) connected via the data communication network, offering efficient resource utilization and dynamic task assignment. The system comprises the software framework with the client-agent device and the language models (which may include large language models, machine-learning models, transformer-based models, neural networks, or generative AI models) within the plurality of autonomous agents, facilitating precise task allocation.

Moreover, the system comprises the processing arrangement that generates the capability mapping structure comprising cryptographic representations of agent functionalities. The capability mapping structure is configured to: (i) store these representations in a space-efficient manner using significantly less storage than complete functionality descriptions; (ii) enable deterministic or probabilistic lookup of agent capabilities through efficient query mechanisms; and (iii) perform cryptographic verification of agent functionality presence or absence, ensuring accurate autonomous agent functionality identification, while proof-based decision-making enhances task execution.

Furthermore, the capability mapping structure can be implemented using various data structures optimized for different operational requirements. In an exemplary embodiment, described in detail below, the capability mapping structure is implemented as a bloom tree, where scalable memory management is achieved by storing root hashes of bloom trees, addresses growing storage demands. Other embodiments employ alternative structures including Merkle trees, probabilistic filters, distributed hash tables, or graph-based representations, each providing space efficiency through different mechanisms suited to specific deployment scenarios. It will be appreciated that the aforementioned features synergistically optimize resource utilization, dynamic task allocation, precise agent selection, efficient task execution, and memory management, making the system ideal for fulfilling the service requests.

In a second aspect, the present disclosure provides a method of operating a distributed computer system for managing and recording functionalities of a plurality of autonomous agents, the distributed computer system comprising a plurality of worker nodes that are coupled together via a data communication network to exchange data therebetween, wherein the plurality of worker nodes include computing arrangements and local databases to process and store data therein, wherein the plurality of worker nodes are the plurality of autonomous agents (AAs), and wherein the distributed computer system is configured to use the plurality of worker nodes for fulfilling a service request, the method comprising:
executing a first set of instructions on a processing arrangement to generate a capability mapping structure comprising one or more data elements, wherein each data element represents a functionality of an autonomous agent of the plurality of autonomous agents, wherein generating the capability mapping structure comprises:
   storing cryptographic representations of agent functionalities in a space-efficient manner;
   configuring the capability mapping structure to enable deterministic or probabilistic lookup of agent capabilities; and
   configuring the capability mapping structure to perform cryptographic verification of agent functionality presence or absence;
receiving, at a client-agent device, the service request;
generating, by the client-agent device, an objective associated with the service request;
sending, by the client-agent device, the objective to at least one autonomous agent of the plurality of autonomous agents, wherein a software framework is implemented, wherein the software framework comprises the client-agent device;
receiving, at a language model comprised in the at least one of the autonomous agents of the plurality of autonomous agents, the objective from the at least one autonomous agent of the plurality of autonomous agents;
generating, by the language model, tasks related to the objective received from the at least one autonomous agent of the plurality of autonomous agents;
sending, by the language model, the generated tasks to the at least one autonomous agent of the plurality of autonomous agents;
executing, by the at least one autonomous agent of the plurality of autonomous agents, a pre-processing operation to generate a plurality of proof values corresponding to the tasks using the capability mapping structure;
sending, by the at least one autonomous agent, the plurality of proof values to the processing arrangement;
executing a second set of instructions on the processing arrangement to identify a list of associated agents of the plurality of autonomous agents by mapping a given proof value to the capability mapping structure;
receiving, at the at least one autonomous agent, from the processing arrangement, the list of associated autonomous agents of the plurality of autonomous agents; and
executing instructions on the associated autonomous agents of the plurality of autonomous agents to perform the tasks required to fulfill the service request by executing at least one action.

The second aspect of the present disclosure provides the method that introduces a streamlined approach to encapsulating autonomous agent capabilities, enhancing efficiency. The method comprises generating the capability mapping structure using cryptographic representations of functionalities, providing an organized functionality representation.

Moreover, the subsequent steps of the method, including the generation of objectives associated with the service requests and the generation of the task by the language models (which may be implemented as large language models, machine-learning models, transformer architectures, neural networks, or generative AI models), facilitate a highly responsive and context-aware approach to task assignment. The synergy between the objective generation and the task generation ensures that the most suitable autonomous agents are selected to fulfill the service requests promptly.

Furthermore, the method uses the pre-processing operation, combined with cryptographic representations, to strengthen security and accuracy in selection of the autonomous agent. The pre-processing operation generates proof values that are matched against the capability mapping structure using lookup mechanisms appropriate to the chosen implementation: exact hash matching for deterministic structures, bit array checks for probabilistic structures, or graph traversal for graph-based structures.

It will be appreciated that the specific mechanisms vary by implementation but all achieve the core objectives of efficient agent identification, cryptographic verification, and space-efficient storage, thereby enhancing efficiency and reliability of the distributed computer system.

Throughout the present disclosure, the term “distributed computer system” as used herein refers to a networked arrangement of multiple worker nodes interconnected through a data communication network. The worker nodes include computing arrangements that are operable to respond to, and processes instructions and data therein. The computing arrangements may include, but are not limited to, a microprocessor, a microcontroller, a complex instruction set computing (CISC) microprocessor, a reduced instruction set (RISC) microprocessor, a very long instruction word (VLIW) microprocessor, an artificial intelligence (AI) computing engine based on hierarchical networks of variable-state machines, or any other type of processing circuit. Furthermore, the computing arrangements can be one or more individual processors, processing devices and various elements associated with a processing device that may be shared by other processing devices. Additionally, the computing arrangements are arranged in various architectures for responding to and processing the instructions that drive the system.

The computing arrangements are processing devices that operate automatically. In such regard, the computing arrangements may be equipped with artificial intelligence algorithms that are configured to respond to and to perform the instructions that drive the system based on data learning techniques. The computing arrangements devices capable of automatically responding and of performing instructions based on input provided from one or more users (namely, the worker nodes participating in the system). The worker nodes further include local databases to store data therein. Furthermore, the collective learning of the worker nodes is managed within the distributed computer system. Notably, the computing model is trained between the plurality of worker nodes in a manner that the intermediary computing models that have been partially trained are shared between the worker nodes and resources of worker nodes are utilized productively.

Moreover, the worker nodes are communicably coupled to each other via the data communication network. The data communication network allows for communication among the plurality of worker nodes. In other words, each of the plurality of worker nodes is capable of communicating with other worker nodes via the data communication network in order to facilitate training of the computing model. Notably, the data communication network refers to an arrangement of interconnected, programmable and/or non-programmable components that, when in operation, facilitate data communication between one or more electronic devices and/or databases. Furthermore, the data communication network may include, but is not limited to, a peer-to-peer (P2P) network, a hybrid peer-to-peer network, local area networks (LANs), radio access networks (RANs), metropolitan area networks (MANs), wide area networks (WANs), all of or a portion of a public network such as global computer network known as the Internet®, a private network, a cellular network and any other communication system. Additionally, the data communication network uses wired or wireless communication that can be carried out via one or more known protocols.

The worker nodes are autonomous agents. Throughout the present disclosure the term “autonomous agents” as used herein, relates to computational entities or software programs that are designed to perform tasks or make decisions autonomously, without direct human intervention. The at least one autonomous agent could perceive their environment, analyze information, and take actions based on predefined rules, algorithms, or learning capabilities. Optionally, the at least one autonomous agent is at least one autonomous economic agent (AEA). In this regard, at least one autonomous micro-agent is optionally a micro autonomous economic agent. Optionally, the at least one autonomous economic agent (AEA) relates to a software module, or any device comprising at least one software module that is configured to execute one or more tasks. Such tasks may include communication of the at least one autonomous economic agents (AEAs) with each other, processing of information, and so forth. In an example, at least one of the autonomous agents are configured to use artificial intelligence (AI) algorithms and machine learning for the execution of the one or more tasks.

The term “service request” as used herein refers to a specific action or communication made by a user, typically through a digitalized system, to seek a particular service or assistance. Optionally, the service request can take various forms, such as direct interactions with digital interfaces like voice assistants (such as Siri, Alexa, ChatGPT, and so forth), inputting information into dedicated applications, or entering appointments into personal calendars. Optionally, the service request may include metadata, which is additional information accompanying the request, and is utilized by the Large Language Model (LLM) to provide relevant inferences or responses. Optionally, the service request may originate from individuals or authorized entities, including the digital twins or company Large Language Models (LLMs) empowered to request services on behalf of the clients, such as arranging travel services.

The term “processing arrangement” as used herein refers to a component designed to execute specific computational tasks or operations. The distributed computer system comprises the processing arrangement. The processing arrangement encompasses hardware, software, or a combination of both, programmed to perform predefined functions. The processing arrangement is used to carry out operations, transformations, or manipulations on data or other inputs to produce desired outputs. Optionally, the processing arrangement could be implemented using various computing devices, including computers, servers, processors, and dedicated hardware modules. Herein the “data” refers to information, records, or values that are collected, stored, processed, or analyzed within the distributed computer system. Optionally, the data include various types of information such as text, numbers, images, audio, video, and so forth.

The term “capability mapping structure” as used herein refers to a data structure configured to manage and record functionalities of autonomous agents in the distributed computer system. The capability mapping structure must satisfy three fundamental functional requirements that enable efficient distributed agent management, regardless of the specific implementation chosen.

The capability mapping structure is configured to store cryptographic representations of agent functionalities in a space-efficient manner. Rather than storing complete descriptions of agent capabilities (which may include detailed specifications, interface definitions, documentation, and metadata), the system stores compact cryptographic representations that uniquely identify functionalities while consuming significantly less storage space.

A “cryptographic representation” refers to a value derived from the functionality description through a cryptographic operation. This representation has several essential properties: (i) determinism—the same functionality description always produces the same cryptographic representation; (ii) uniqueness—different functionalities produce different representations (with negligible collision probability); (iii) compactness—the representation requires substantially less storage than the original functionality description; and (iv) one-way property—the representation cannot be reverse-engineered to recover the complete original functionality description without additional information.

The space efficiency is achieved through various mechanisms depending on implementation. Tree-based implementations achieve space efficiency by storing only hash values at nodes rather than full functionality descriptions, with hierarchical organization enabling compression through shared parent nodes. Probabilistic implementations use bit arrays where multiple functionalities share storage space through hash-based mapping, achieving even greater compression with acceptable accuracy tradeoffs. Hash table implementations achieve efficiency through compact key-value pairs where keys are fixed-size hashes regardless of functionality description length. Graph-based implementations store only node identifiers and edge relationships rather than complete capability specifications at each node, with graph compression techniques further reducing storage requirements.

The degree of space efficiency varies by implementation but typically achieves storage reduction factors of 10× to 1000× compared to storing complete functionality descriptions. For example, a 10 kilobyte functionality specification might be represented by a 256-bit (32 byte) hash value, achieving approximately 320× compression. In probabilistic structures supporting shared storage, multiple functionalities may share space, achieving compression ratios exceeding 1000× with configurable false positive rates (typically 0.01% to 1%).

The capability mapping structure is configured to enable deterministic or probabilistic lookup of agent capabilities. This requirement ensures that when a service request requires certain capabilities, the system can efficiently identify which agents possess those capabilities.

The term “deterministic lookup” refers to query operations that return exact, definitive results with zero error rate. When querying for a capability, deterministic lookup returns either: (i) a confirmed presence indication—the capability definitely exists in the structure, with zero false positive rate; or (ii) a confirmed absence indication—the capability definitely does not exist, with zero false negative rate. Deterministic lookups are characteristic of hash table-based structures (which provide exact key-value matching), certain tree-based structures (which can verify exact node presence), and graph-based structures (which maintain complete node and edge information).

The term “probabilistic lookup” refers to query operations that return results with defined confidence levels and accept tradeoffs between accuracy and efficiency. When querying for a capability, probabilistic lookup returns: (i) a presence indication with specified false positive rate—the capability likely exists with probability defined by the data structure parameters (typically 99-99.99% confidence); or (ii) a confirmed absence—if the structure indicates absence, the capability definitely does not exist (zero false negative rate is maintained). Probabilistic lookups trade perfect accuracy for superior space efficiency and are characteristic of bloom filters, cuckoo filters, count-min sketches, quotient filters, and similar probabilistic data structures.

The capability mapping structure may support only deterministic lookup (hash tables, certain tree structures), only probabilistic lookup (bloom filters, count-min sketches), or both modes depending on implementation. Hybrid implementations may use deterministic lookup for critical capability queries where false positives are unacceptable and probabilistic lookup for preliminary filtering, non-critical queries, or scenarios where approximate results suffice. The choice between deterministic and probabilistic modes involves tradeoffs between storage efficiency (probabilistic structures use significantly less space), query accuracy (deterministic provides perfect accuracy), and computational overhead (probabilistic typically offers faster queries).

Lookup operations are implemented through various mechanisms depending on structure type. Hash-based lookups compute hash values of capability queries and check storage locations (O(1) complexity). Tree traversal operations navigate hierarchical structures from root to leaves following hash comparisons (O(log n) complexity). Graph traversal operations follow edges from starting nodes to discover related capabilities using breadth-first search, depth-first search, or specialized graph algorithms (O(V+E) complexity where V is vertices, E is edges). Bit array checks compute multiple hash values and verify corresponding bit positions are set (O(k) complexity where k is number of hash functions, typically small constant).

The capability mapping structure is configured to perform cryptographic verification of agent functionality presence or absence. This requirement ensures that the system can verify capability claims in a tamper-proof manner without relying solely on agent self-reporting, which is critical in untrusted or partially-trusted distributed environments.

Cryptographic verification involves three steps: (i) receiving a proof value from an autonomous agent claiming to possess a functionality; (ii) executing hash comparison operations between the received proof value and stored cryptographic representations within the capability mapping structure; and (iii) generating a verification result that indicates presence or absence of the functionality with cryptographic certainty.

The “proof value” is a cryptographic representation generated by the agent using the same cryptographic operations employed by the capability mapping structure when originally recording agent functionalities. If an agent legitimately possesses a functionality, it can generate the correct proof value by applying the cryptographic function to its functionality description or related data. If an agent does not possess the functionality or attempts to forge a capability claim without knowledge of the underlying functionality, it cannot generate the correct proof value without breaking the cryptographic function (which is computationally infeasible for properly chosen cryptographic hash functions like SHA-256, SHA-3, or similar).

Hash comparison operations verify that the proof value matches stored representations, with specific mechanisms varying by implementation. In tree-based structures, verification may involve reconstructing a root hash from the proof value combined with a verification path (series of sibling node hashes), then comparing the reconstructed root against the stored root. In probabilistic structures, verification involves applying hash functions to the proof value and checking whether all resulting bit positions are set in the bit array. In hash table structures, verification involves key lookup to confirm the proof value exists as a key in the table. In graph-based structures, verification involves confirming that a node with a hash value matching the proof value exists in the graph.

The verification result indicates whether the agent's claimed functionality is consistent with the capability mapping structure's records. A positive verification means the agent either possesses the functionality or successfully generated the correct cryptographic proof, which requires knowledge of the functionality or ability to break the cryptographic function (computationally infeasible). A negative verification definitively means the agent does not possess the functionality or provided an incorrect proof value. In probabilistic implementations, verification may include confidence metrics or probability scores indicating the reliability of the positive result (e.g., “99.5% confidence of presence”), while negative results remain definitive.

Cryptographic verification provides multiple security properties: (i) Capability forgery prevention-agents cannot claim functionalities they don't possess without knowledge of the underlying functionality description that produces the correct hash; (ii) Impersonation prevention—agents cannot impersonate other agents' capabilities without access to those agents' functionality data; (iii) Tampering detection—any modification to capability records is detectable through hash mismatches since changing even one bit of input produces completely different hash output; (iv) Replay attack resistance-proof values can be combined with session identifiers, timestamps, or nonces to prevent malicious reuse of valid proof values from previous legitimate authentications.

The capability mapping structure can be implemented using various data structure types, each optimized for different operational requirements and deployment scenarios. The selection of implementation depends on factors including: required lookup accuracy (deterministic vs. probabilistic), storage constraints, agent population size, update frequency, query patterns, and relationship representation needs. The following implementations are described in detail:
(i) Tree-based data structures that organize cryptographic hash values in hierarchical arrangements, providing efficient traversal, verification properties, and logarithmic scaling characteristics;
(ii) Probabilistic data structures that use bit arrays and hash functions to provide space-efficient representation with configurable accuracy tradeoffs;
(iii) Hash table-based data structures that provide deterministic key-value lookups for exact capability matching with constant-time complexity;
(iv) Graph-based data structures that represent capability relationships through nodes and edges, enabling relationship-aware agent discovery and compositional capability queries.

The term “cryptographic hash value” as used herein refers to a fixed-size, alphanumeric string of characters generated by applying a specific mathematical algorithm known as a cryptographic hash function to input data. The hash functions are designed to take an arbitrary amount of data (input) and produce a unique, fixed-length output, which appears as a seemingly random sequence of characters. Common cryptographic hash functions include SHA-256 (producing 256-bit outputs), SHA-3, BLAKE2, or similar functions with properties of collision resistance, preimage resistance, and avalanche effect (small input changes produce dramatically different outputs).

In this regard, the processing arrangement gathers information about the functionalities of the autonomous agents. Each autonomous agent has one or more functionalities that need to be stored and managed within the capability mapping structure. For each functionality, the processing arrangement produces a cryptographic representation (such as a cryptographic hash value, fingerprint, bit pattern, or other identifier) that uniquely characterizes the functionality while requiring minimal storage space.

The specific mechanism for generating and organizing these cryptographic representations depends on the implementation of the capability mapping structure:
(i) In tree-based implementations: The processing arrangement generates cryptographic hash values by applying hash functions to functionality descriptions and organizes them into hierarchical nodes (parent-child relationships) with non-leaf nodes containing hashes of their children.
(ii) In probabilistic implementations: The processing arrangement applies multiple hash functions (k functions where k depends on desired false positive rate) to generate bit positions or fingerprint values that are set/stored in the structure's bit arrays.
(iii) In hash table implementations: The processing arrangement generates hash keys for deterministic lookup, with keys mapping to values containing agent identifiers and capability metadata.
(iv) In graph-based implementations: The processing arrangement creates nodes with associated hash values representing capabilities and establishes edges representing capability relationships (dependencies, compositions, similarities).

Herein, the software framework encompasses any software abstraction which can have one or more software modules to provide generic and/or specific functionality (or specific functionalities). The software framework can be implemented by a distributed ledger arrangement. Optionally, the software framework is an agent framework (i.e., a framework that enables the creation of application-specific autonomous agents), an open economic framework (OEF) using autonomous economic agents, or a framework designed for developers (person or by artificial intelligence) to develop applications where both agents and a large language model are included in the application. The software framework provides the infrastructure and resources for the autonomous agents to communicate, negotiate, and exchange value in a secure and transparent manner. Optionally, the software framework includes the plurality of autonomous agents which are communicably interconnected using a direct network link (such as a decentralized computing network).

The software framework can be implemented using various distributed ledger arrangements, agent frameworks, or cloud-based platforms. Optionally, the software framework is an agent framework (i.e., a framework that enables the creation of application-specific autonomous agents), an open economic framework (OEF) using autonomous economic agents, or a framework designed for developers (person or by artificial intelligence) to develop applications where both agents and language models (including large language models) are included in the application. The software framework provides the infrastructure and resources for the autonomous agents to communicate, negotiate, and exchange value in a secure and transparent manner. Optionally, the software framework includes the plurality of autonomous agents which are communicably interconnected using a direct network link (such as a decentralized computing network).

The software framework comprises the client-agent device. In this regard, the client-agent device is any device that acts as a client for the system, and in particular for the autonomous agents. Examples of the client-agent device include an organization on the cloud seeking a service, an end user with a phone seeking a service or a decentralized autonomous organization (DAO) seeking a service. In this regard, the client-agent device is configured to receive the service request.

Optionally, the service request is received from at least one of: a software application executing on a device of a user, a software application executing on a computing device that is communicably coupled to a device of a user, a cloud-based software application, a digital twin of a user, a digital representation of a user, an artificial intelligence model (AI-model) based on a Large Language Model (LLM). In this regard, for example, the software application could be a travel planning application. In such a case, a user may use the travel planning application on their smartphone to make a service request to book a hotel. Optionally, the software application could be a home automation hub that is communicably coupled to the user's device (such as a smartphone) through a wireless connection. Optionally, the cloud-based software application could be a Google Calendar. Optionally, the service request can be received from the digital twin that refers to a virtual representation of a given user. Optionally, the given digital twin employs simulation, machine learning and reasoning to assist in decision-making. For example, the digital representation could be a chatbot or an avatar that interacts with the distributed computer system on the user's behalf.

The term “objective” as used herein refers to a desired outcome or goal that the client-agent device aims to achieve based on the service request received therethrough. Optionally, the objective defines the purpose or intent behind the service request. In this regard, the objective is generated by the client-agent device according to the service request. The objective is typically formulated in a structured manner to provide clarity and guidance for the subsequent actions of the client-agent device and the plurality of autonomous agents in the distributed computer system. For example, the objective could be to book a flight to Paris, when the service request is to find and book a flight to Paris. In another example, the objective could be to schedule a meeting with an individual on a specific day. It will be appreciated that the client-agent device generates the objective to ensure an effective communication and a well-defined context for the subsequent actions taken by the plurality of autonomous agents in response to the service request.

Herein, the term “language model” as used herein refers to computational models configured to process, understand, analyze, and generate structured task descriptions from service request objectives. The language model employs artificial intelligence, machine learning, or computational techniques to decompose high-level objectives into concrete, executable tasks that can be assigned to autonomous agents. The language model is trained, programmed, or configured to understand the semantic content of objectives and generate appropriate task sequences.

Language models may be implemented using various architectures and training methodologies, each optimized for different task generation scenarios:
(i) Large Language Models (LLMs): Neural network models trained on extensive text corpora (billions to trillions of tokens), enabling them to understand natural language objectives across multiple domains without domain-specific training. LLMs employ transformer architectures with billions of parameters, using pre-training on broad datasets followed by optional fine-tuning for specific task generation applications. Examples include GPT-family models, BERT-based models, or similar architectures. When receiving an objective, the LLM applies natural language understanding techniques to parse the objective, identify key requirements, constraints, and goals, and generates a structured set of tasks through learned patterns of objective-task mappings.
(ii) Machine-Learning Models: Models employing supervised learning (trained on labeled examples of objectives paired with correct task decompositions), unsupervised learning (discovering patterns in objective-task structures without explicit labels), or reinforcement learning (learning optimal task generation through reward signals from successful service fulfillment). These models may use various architectures including decision trees, support vector machines, random forests, or neural networks, depending on the complexity of objective-task mappings in the deployment domain.
(iii) Transformer-Based Models: Models utilizing self-attention mechanisms to analyze relationships between different components of an objective. The multi-head attention architecture enables the model to focus on different aspects of the objective simultaneously (e.g., one attention head focuses on temporal constraints, another on resource requirements, another on quality criteria). The transformer processes the objective through multiple attention layers, each learning different aspects of the objective-to-task mapping, and generates tasks with appropriate dependencies, ordering, and parallelization opportunities.
(iv) Neural Network Models: Models employing multi-layer architectures including feed-forward networks (for simple objective-task mappings), recurrent neural networks or LSTMs (for sequential task generation considering order dependencies), or convolutional neural networks (for objectives with spatial or hierarchical structure). These models learn mappings from objective representations (embeddings, feature vectors) to task sequence representations through backpropagation training on objective-task datasets.
(v) Generative AI Models: Models capable of producing novel task decompositions by learning probabilistic distributions over possible task configurations given objectives. These include variational autoencoders (learning latent representations of task sequences), generative adversarial networks (learning to generate realistic task sequences through adversarial training), or diffusion models (generating tasks through iterative denoising processes). Generative models can create task sequences not explicitly seen during training by interpolating or extrapolating from learned patterns.

The language model receives an objective in structured format (JSON, XML, protocol buffers) or natural language format (text descriptions). It parses the objective to identify: required outcomes (what must be accomplished), constraints (limitations on time, cost, resources, quality), success criteria (how to measure fulfillment), resource requirements (computational, data, external services), temporal requirements (deadlines, sequencing), quality expectations (accuracy, reliability, performance metrics), and contextual factors (user preferences, historical patterns, environmental conditions).

Based on analyzed objectives, the language model generates a set of tasks that collectively fulfill the objective. Task generation considers: task dependencies (which tasks must complete before others can begin), parallel execution opportunities (which tasks can execute simultaneously without conflicts), resource requirements (which agent capabilities each task requires), error handling strategies (alternative tasks if primary tasks fail), and optimization opportunities (more efficient task sequences, resource sharing).

Each generated task includes: a task description specifying the required action in structured or natural language format, required capabilities or functionalities needed to execute the task, input data requirements (data types, formats, sources), expected output format (data structures, file formats, communication protocols), success criteria (validation conditions, quality thresholds), and priority or sequencing information (execution order, deadlines, dependencies on other tasks).

The language model may be comprised within a single autonomous agent that coordinates task distribution, or multiple agents may have language model capabilities for distributed task generation. The phrase “comprised in at least one of the autonomous agents” indicates that the language model executes as part of the autonomous agent's computational processes, though the physical implementation may range from co-located processors to distributed computing resources (cloud-based language model APIs, distributed model inference across multiple nodes) accessible through the data communication network. In distributed implementations, the autonomous agent sends the objective to the language model service and receives generated tasks through network communication.

The machine learning model may provide insights and information based on previous queries or experiences, learning from historical service requests to improve task generation quality over time. Optionally, the machine learning model might provide recommendations based on factors like agent availability, cost optimization, or user preferences when generating tasks.

The term “pre-processing operation” refers to any collection or set of instructions executable by a processor to obtain the plurality of proof values. Additionally, the pre-processing operation is intended to encompass such instructions stored in storage medium such as random-access memory (RAM), a hard disk, optical disk, or so forth, and is also intended to encompass software stored on a read only memory (ROM) or so forth of the at least one autonomous agent. In an example, the pre-processing operation is potentially a one-time operation executed by each of the at least one autonomous agent before they are ready to initiate an interactive proof to verify the presence of the corresponding tasks by interacting with other autonomous agents.

The specific operations performed during pre-processing depend on the capability mapping structure implementation. In tree-based implementations, pre-processing involves computing hash values of task requirements and formatting them to match tree node structures. In probabilistic implementations, pre-processing involves applying multiple hash functions to generate bit positions or fingerprints. In hash table implementations, pre-processing involves generating lookup keys. In graph-based implementations, pre-processing involves identifying relevant capability nodes and formulating graph queries.

The term “proof value” as used herein refers to a piece of data or information. Moreover, each proof value is associated with particular tasks or operations that the system needs to perform. The proof value act as guarantees that the tasks have been processed correctly. In this regard, after generating the proof values, the language model sends the proof values to the processing arrangement. The processing arrangement is responsible for further handling and potentially verifying the plurality of proof values.

The specific format and generation method of proof values varies by capability mapping structure implementation:
(i) In tree-based structures: A proof value may be a single hash value representing the task requirement, potentially accompanied by a verification path (series of sibling node hashes for Merkle proof verification).
(ii) In probabilistic structures: A proof value may comprise multiple hash values or bit positions generated by applying k hash functions to the task requirement.
(iii) In hash table structures: A proof value is a hash key used for deterministic lookup in the hash table.
(iv) In graph-based structures: A proof value may be a node identifier or a set of identifiers representing required capabilities and relationships.

The at least one autonomous agent, when in operation, executes instructions to configure the processing arrangement to perform a specific task: identifying a group of autonomous agents that are related or connected to the given proof value. This is done by mapping the proof value to the capability mapping structure-associating the given proof value with specific data elements or locations within the structure.

The mapping operation's specific mechanism depends on the capability mapping structure implementation:
(i) In tree-based structures: Mapping involves traversing the tree from root toward leaves, comparing the proof value against hash values stored at nodes. The traversal follows branches where hash comparisons indicate potential matches, ultimately identifying leaf nodes or subtrees corresponding to agents with matching capabilities.
(ii) In probabilistic structures: Mapping involves applying hash functions to the proof value to generate bit positions or fingerprints, then checking those positions in the structure's bit arrays. If all checked positions contain set bits (or fingerprints match), the structure indicates the capability likely exists.
(iii) In hash table structures: Mapping involves using the proof value as a lookup key. The hash table directly returns the value associated with that key, which contains agent identifiers possessing the capability.
(iv) In graph-based structures: Mapping involves identifying the node corresponding to the proof value, then executing graph traversal algorithms (breadth-first search, depth-first search, or specialized queries) to discover agents with related capabilities following edge relationships.

The at least one autonomous agent receives from the processing arrangement the list of associated autonomous agents-a clear and defined set of autonomous agents that are deemed relevant or suitable for addressing the service request. The associated autonomous agents are configured to perform the tasks required to fulfil the service request. Additionally, tasks can have multiple sub-tasks. Then accordingly the proof values of each subtask will be generated and matched with the capability mapping structure to find the associated autonomous agents.

In a first exemplary embodiment that provides particular advantages for combining space efficiency with cryptographic verification while minimizing false positives through invertible properties, the capability mapping structure is implemented as a “bloom tree”. The term “bloom tree” as used herein refers to a specialized data structure that organizes data hierarchically. In this regard, the bloom tree is used to efficiently store and manage the cryptographic hash values representing the functionalities of the autonomous agents. Herein, the functionality of the autonomous agent refers to the specific capabilities, tasks, or functions that enable the at least one autonomous agent to serve the service request. Such functionalities may be enabling digital payments, generating product recommendations, resolving customer queries, and the like. Optionally, the functionality of the autonomous agent is related to current or previous tasks handled by the autonomous agent.

In the bloom tree implementation specifically, the processing arrangement gathers information about the functionalities of the autonomous agents. Each of the autonomous agent has a unique functionality and needs to be stored and managed. For each of the functionalities, the processing arrangement produces the cryptographic hash value. Optionally, the cryptographic hash values are produced by applying hash function on the context of tasks being handled or previously handled by the autonomous agent. The cryptographic hash values are unique to each functionality and serve as a kind of fingerprint. The processing arrangement assembles the cryptographic hash values in order to generate the bloom tree.

Optionally, the pre-processing operation includes multiple hashing of the tasks depending upon an invertible bloom filter size to generate the given proof value. Herein, the multiple hashing of tasks refers to the process of applying a hash function repeatedly to a set of tasks. Moreover, each time a task is hashed, it undergoes a transformation that produces a fixed-size output, known as a hash value or hash code. Furthermore, the hash values are generated sequentially, with the output of one hashing operation becoming the input for the next. It will be appreciated that the multiple hashing enhances data integrity, reduces false positives, and improves the accuracy of identifying the tasks within the system. Herein, the invertible bloom filter size indicates a number of functionality representations of the autonomous agents, the invertible bloom filter could efficiently store. Optionally, the invertible bloom filter sizes are typically measured in terms of bits or bytes.

Optionally, the pre-processing operation includes multiple hashing of the list of subtasks to get the invertible bloom filter value to be sent to other autonomous agents to check if the other autonomous agents have the same functionality. Optionally, each subtask in the list has a corresponding proof value. Optionally, the system will identify each relevant/associated agents based on the proof value. Optionally, the proof value is calculated by hashing sub-task k times (depending upon the invertible bloom filter size).

Optionally, the given proof value is generated through the process of multiple hashing of tasks, which depends on the size of the invertible bloom filter. Optionally, the given proof value serves as a unique identifier or representation of the tasks and their associated functionality. Advantageously, the pre-processing ensures that similar functionalities or tasks are accurately identified and reduces the likelihood of false positives, which is essential for the system reliability.

Optionally, the given proof value corresponds to the invertible bloom filter data elements for the task. Herein, the invertible bloom filter data elements refer to the specific attributes, features, or information that define the task to be performed by the autonomous agent. Optionally, the invertible bloom filter data elements can include various parameters, descriptions, or metadata that uniquely describe the task, such as its requirements, inputs, expected outputs, or dependencies. Optionally, the given proof value is computed based on the invertible bloom filter data elements associated with the task, optionally through the multiple hashing. It will be appreciated that by having the given proof value correspond to the invertible bloom filter data elements, any change or modification to the task's attributes will result in a different proof value, ensuring the data integrity.

Optionally, the bloom tree is a tree structure where a node of the tree represents the invertible bloom filter data elements based on current functionality of the autonomous agent. In this regard, the bloom tree is described as the tree structure, meaning that the bloom tree is organized in a hierarchical manner similar to a traditional tree. Optionally, each node of the tree corresponds to the invertible bloom filter data elements related to the autonomous agent's functionality. Optionally, the hierarchical nature of the tree implies that the invertible bloom filter data elements are organized into levels, with higher-level nodes potentially representing broader or more general characteristics, while lower-level nodes represent finer details or specific functionalities. Optionally, the tree structure represents the current functionality of the autonomous agent, meaning that it reflects the autonomous agent's real-time capabilities and characteristics. Optionally, when the functionality changes, the tree structure can be updated to reflect the functionality changes.

Optionally, the bloom tree structure is like the known Merkle tree used for bandwidth-efficient and secure verification of the presence of a given transaction in a decentralized system. In an example, Merkle tree is a binary tree in which all leaf nodes (that are transactions such as T₁, T₂, T₃ to T₈) are associated with a hash (such as H₁, H₂, H₃ to H₈), and all none-leaf nodes are associated with a hash (such as H_{1,2}, H_{3,4}, H_{5,6}, H_{6,7}, H_{1,2,3,4} and H_{5,6,7,8}), that is formed from the hashes of its child nodes. Moreover, a root hash of the Merkle tree is obtained by hashing the non-leaf nodes (such as H_{1,2,3,4}, and H_{5,6,7,8}). To verify that a single transaction is present in the Merkle tree, a series of hashes are provided, which when are hashed with the transaction hash (e.g., a hash of transaction ID), a root hash of the Merkle tree is recreated. Moreover, this series of hashes is also known as a Merkle proof.

In the present disclosure, the bloom tree is used which combines the invertible bloom filters with Merkle trees. Moreover, using the bloom tree, the presence or absence of any existing agent's functionality is identified and communicated in a secure and bandwidth efficient way. Further, the use of invertible bloom filter helps in identifying accurately if an autonomous agent with the same functionality as required to fulfil a task or sub-task of a service request is present or not. In. this regard, in the distributed computer system, by defining the functionality (or capability) of each autonomous agent (AA) as an invertible bloom filter, the probability of identifying an existing autonomous agent (AA) matching with the service request will be 1 and the probability of identifying an autonomous agent (AA) no longer existing in the tree will be 0.

Optionally, the distributed computer system operates to configure each autonomous agent of the plurality of autonomous agents to execute the pre-processing operation further to calculate the cryptographic representations of their current functionalities. Each autonomous agent then shares these cryptographic representations with the processing arrangement dynamically as soon as a new service request is received or when agent capabilities change. The processing arrangement is then configured to update the capability mapping structure to reflect current agent functionalities.

By configuring the autonomous agents to calculate their cryptographic representations, this approach reduces the processing overload for the processing arrangement (distributed computation) and reduces the data communication overhead as the cryptographic representations are small size.

Optionally, the autonomous agents are configured to share the calculated cryptographic representations with the processing arrangement only if the there is a change or update in the functionality of the autonomous agent from the one previously shared. This incremental update approach further optimizes network communication and processing resources.

The distributed computer system thus makes an economical use of the memory and communication resources as only the cryptographic representations are stored and communicated instead of full functionality. The specific update mechanism varies by implementation: tree-based structures may require reconstructing parent node hashes up to the root; probabilistic structures may require setting new bit positions or inserting new fingerprints; hash tables require inserting or updating key-value pairs; graph-based structures require adding new nodes or edges.

In the bloom tree implementation specifically, the autonomous agents calculate cryptographic hash values representing their functionalities. By sharing the functionality of the autonomous agents using cryptographic hash values organized into invertible bloom filter combined with Merkle tree structure, the security of the distributed system is improved through both the cryptographic properties of hash functions and the verification properties of Merkle trees.

In one alternative tree-based implementation, the capability mapping structure comprises a Merkle tree comprising leaf nodes associated with functionality hashes and non-leaf nodes associated with hashes formed from child nodes. Each autonomous agent's functionality is processed by applying a cryptographic hash function to create a leaf node value. The hash function takes as input the agent identifier combined with the functionality description. This produces a unique hash value for each agent's capability, which becomes the content of a leaf node at the bottom level of the tree.

Above the leaf level, the processing arrangement creates parent nodes by hashing together the values of child nodes. Specifically, two adjacent leaf nodes are paired together, their hash values are concatenated, and this combined data is hashed to produce the parent node's value. This process continues upward through successive levels of the tree, with each parent node's hash derived from its children's hashes, until reaching a single root node at the top of the tree.

The root hash serves as a compact cryptographic fingerprint representing all agent functionalities in the entire system. Any change to any agent's functionality produces a completely different root hash due to the properties of cryptographic hash functions. The root hash typically comprises only thirty-two bytes for standard hash functions such as SHA-256, yet cryptographically represents potentially millions of agent functionality records.

When an autonomous agent needs to verify that another agent possesses a claimed functionality, the verification process uses a Merkle proof. The Merkle proof consists of the minimum set of hash values needed to reconstruct the path from a leaf node to the root node. Specifically, the proof includes the hash values of sibling nodes at each level along the path from the claimed functionality's leaf position up to the root.

The verifying agent receives the claimed functionality hash and the Merkle proof. It then reconstructs the root hash by starting with the claimed functionality hash and repeatedly hashing it together with each sibling hash from the proof, working upward through each level until computing a final root hash value. If this computed root hash matches the authentic root hash stored in the system, the verification succeeds, confirming that the claimed functionality is genuinely recorded in the capability mapping structure.

To enable efficient lookup operations, the processing arrangement optionally maintains an auxiliary hash table that maps leaf hash values to agent identifiers. When a proof value is received during capability matching, the system uses this hash table to directly look up which agents possess the required capability, achieving constant-time lookup performance rather than requiring traversal through the entire tree structure.

When agent functionalities change, the Merkle tree is updated incrementally rather than being completely reconstructed. The processing arrangement recomputes only the affected leaf node and then recalculates each parent node along the path from that leaf up to the root. This incremental update process requires logarithmic time relative to the total number of agents, making updates efficient even for large agent populations.

The Merkle tree implementation provides deterministic lookup with zero false positives and zero false negatives. When a proof value matches a leaf hash, the capability definitely exists. When no match is found, the capability definitely does not exist. This deterministic property is valuable for applications requiring guaranteed accuracy in capability identification.

The Merkle tree implementation is particularly suitable for blockchain-based agent systems where Merkle trees are already widely used and understood, for regulatory compliance environments requiring auditable capability management with cryptographic proof capabilities, and for systems where deterministic verification is essential and the additional storage overhead compared to probabilistic structures is acceptable.

In alternative embodiments optimizing for maximum space efficiency while accepting configurable false positive rates, the capability mapping structure comprises probabilistic data structures using bit arrays and hash functions for efficient capability representation and lookup.

In one probabilistic implementation, the capability mapping structure comprises a cuckoo filter. The cuckoo filter is a space-efficient data structure that supports testing whether an element is a member of a set, while also supporting deletion of elements.

The cuckoo filter maintains an array of storage locations called buckets. Each bucket can hold a small number of fingerprints, typically between two and eight fingerprints per bucket. A fingerprint is a short bit string derived from hashing a functionality description. Rather than storing the complete hash value, the filter stores only a short fingerprint, typically between eight and sixteen bits in length.

When recording an agent's functionality, the processing arrangement first generates a fingerprint by applying a hash function to the agent identifier combined with the functionality description, then extracting a fixed number of bits from the resulting hash value to form the fingerprint.

The filter then calculates two candidate bucket locations where this fingerprint might be stored. The first bucket location is determined by hashing the functionality description. The second bucket location is determined by taking the first bucket location and combining it with a hash of the fingerprint using an XOR operation. This approach enables computing either bucket location from the other if the fingerprint is known, which is important for supporting deletion operations.

During insertion, the processing arrangement first checks whether either of the two candidate buckets has an empty slot. If so, the fingerprint is placed in that empty slot and insertion succeeds immediately. If both candidate buckets are full, the filter employs a displacement mechanism: it randomly selects one of the two buckets, removes an existing fingerprint from that bucket, inserts the new fingerprint in its place, and then attempts to reinsert the displaced fingerprint into its alternate bucket location. This displacement process may cascade through multiple buckets until finding an empty slot or reaching a maximum displacement limit.

Lookup operations check both candidate bucket locations for the presence of a matching fingerprint. The system generates a proof fingerprint from the required capability and checks whether this fingerprint appears in either of its two candidate buckets. If found, the capability is reported as likely present. If not found in either bucket, the capability is definitely absent.

The cuckoo filter provides probabilistic lookup results. False positives can occur when different functionalities happen to produce identical fingerprints due to the short fingerprint length. The false positive rate depends on the fingerprint length and bucket configuration. For example, using sixteen-bit fingerprints with four fingerprints per bucket typically achieves false positive rates below one percent. However, the filter guarantees zero false negatives: if the filter reports a capability as absent, it is definitely not present in the system.

In another probabilistic implementation, the capability mapping structure comprises a count-min sketch. The count-min sketch is particularly useful for tracking how frequently different capabilities appear across the agent population. The count-min sketch maintains a two-dimensional array of counters organized into multiple rows, with each row corresponding to a different hash function. When recording an agent's functionality, the processing arrangement applies multiple hash functions to the functionality description, generating one array position per hash function. The counter at each of these positions is then incremented.

To query whether agents with a specific functionality exist, the system applies the same hash functions to generate array positions and examines the counter values at those positions. The minimum counter value across all checked positions provides a frequency estimate that never underestimates the true count but may overestimate due to hash collisions with other functionalities.

The count-min sketch requires relatively modest storage. The total storage depends on the array dimensions and counter size. Typical configurations use counters of four to eight bits each, with array dimensions chosen based on desired accuracy guarantees. For many practical applications, the structure requires approximately ten to fifteen bits per tracked capability. This implementation is particularly suitable for systems requiring frequency-aware agent selection, where knowing how many agents possess certain capabilities aids in load balancing or capability distribution analysis.

In yet another probabilistic implementation, the capability mapping structure comprises a quotient filter. The quotient filter divides hash values into two parts: a quotient and a remainder. When hashing a functionality description, the resulting hash value is partitioned into a quotient portion and a remainder portion. The quotient determines where the entry should ideally be stored in the filter's array, while only the remainder portion is actually stored, along with some metadata bits that track whether entries have been displaced from their ideal positions.

In alternative embodiments prioritizing deterministic exact matching with constant-time lookup performance, the capability mapping structure comprises hash table-based data structures using key-value pairs for capability lookup.

In one hash table implementation particularly suited for distributed computing environments, the capability mapping structure comprises a distributed hash table implementing a consistent hashing protocol. The distributed hash table spreads agent functionality records across multiple processing arrangements in the data communication network.

In a distributed hash table, functionality records are distributed across nodes using a consistent hashing mechanism. Each functionality description is hashed to produce a key value. This key is then mapped to a responsible node in the network. Both nodes and keys are conceptually arranged on a circular hash space, similar to a ring. Each node is responsible for storing functionality records whose keys fall in the range between that node and its predecessor node on the ring.

When a new autonomous agent joins the system or an existing agent updates its functionality, the processing arrangement hashes the functionality to determine the key, then identifies which node is responsible for that key position on the ring. The functionality record is stored on that responsible node.

When an autonomous agent needs to find agents possessing a particular capability, it generates a proof value by hashing the required capability description. This proof value serves as a lookup key. The system then determines which node is responsible for that key position and queries that node. The responsible node returns the list of agent identifiers associated with matching functionality records.

A significant advantage of consistent hashing is stability when nodes join or leave the network. When a node is added to or removed from the system, only functionality records in the immediate vicinity of that node on the hash ring need to be relocated. The majority of functionality records remain on their current nodes, avoiding the need to redistribute all data across the network.

Different distributed hash table protocols implement the routing differently. Some protocols maintain routing tables that enable finding responsible nodes in logarithmic time relative to the total number of nodes. Other protocols use different routing strategies optimized for particular network characteristics or fault tolerance requirements.

The distributed hash table approach is particularly suitable for large-scale distributed systems where centralized capability storage would create a performance bottleneck, for peer-to-peer agent networks requiring decentralized coordination without central authority, and for systems prioritizing fault tolerance through data replication, since each functionality record can be replicated across multiple successor nodes on the ring for redundancy.

Storage requirements in the distributed hash table are distributed across nodes. Each node stores its allocated portion of functionality records, with storage per node proportional to the total number of functionalities divided by the number of nodes in the network. Additionally, each node maintains routing information to enable efficient lookup operations, typically requiring logarithmic space relative to the total number of nodes.

In alternative embodiments enabling relationship-aware capability discovery, the capability mapping structure comprises a graph-based data structure with nodes representing agent capabilities and edges representing capability relationships. In the graph-based implementation, each node in the graph represents a discrete capability or functionality that autonomous agents can perform. Each node stores a cryptographic hash value identifying the capability, along with identifiers of agents possessing that capability and relevant metadata describing capability characteristics such as performance metrics or resource requirements.

Multiple agents may share the same capability node if they possess identical or equivalent functionalities. This provides natural compression where many agents with common capabilities reference the same node rather than each having separate records.

Edges between nodes indicate various types of relationships between capabilities. Prerequisite relationships use directed edges to show that one capability requires another capability to function properly. For example, an edge from capability A to capability B indicates that capability B must be available for capability A to operate.

Composition relationships indicate that multiple simpler capabilities can be combined to enable a higher-level capability. Directed edges from component capabilities to the composite capability represent these relationships. This enables the system to discover that even if no single agent possesses a complex capability, multiple agents might work together by combining their simpler capabilities.

Similarity relationships use undirected edges to indicate that capabilities are functionally related, substitutable, or complementary. When an exact capability match is not found, the system can traverse similarity edges to discover alternative capabilities that might fulfill the requirement.

Mutual exclusion relationships indicate incompatible capabilities that cannot be possessed by the same agent simultaneously. These relationships help the system avoid assigning tasks to agents whose capability combinations would create conflicts.

Edges may optionally include weight values encoding the strength, confidence, or cost associated with the relationship. These weights enable the system to prefer certain relationship paths over others when multiple options exist.

When an autonomous agent executes pre-processing to identify associated agents, it generates a proof value by hashing the required capability description. The system then locates the node in the graph whose hash value matches or is closest to this proof value.

Starting from the matched node, the processing arrangement executes graph traversal algorithms to explore the capability space. The specific traversal algorithm depends on the query requirements and relationship semantics. Breadth-first search explores nodes level by level outward from the starting point, finding capabilities at increasing relationship distances. Depth-first search follows relationship paths deeply before backtracking, useful for exploring prerequisite chains. Specialized graph algorithms may be employed for particular query patterns or relationship types.

For prerequisite relationships, the traversal follows incoming edges to discover dependencies that must be satisfied. The system identifies not only agents with the directly required capability but also agents possessing prerequisite capabilities needed to support the primary requirement.

For composition relationships, the traversal follows outgoing edges to discover higher-level capabilities that the required capability helps enable. This allows the system to understand how the required capability fits into larger functional goals.

For similarity relationships, the traversal explores neighboring nodes to find alternative or complementary capabilities. When an exact match for a required capability is not available, the system can suggest agents with similar capabilities that might substitute or be adapted to fulfill the requirement.

Query results return not just agents with exact capability matches, but agents with related capabilities that might be composed, substituted, or upgraded to fulfill requirements. This relationship-aware discovery enables more flexible and intelligent agent selection compared to exact-match-only structures. Storage and Distribution

The graph structure can be stored using various representations. Adjacency list representation stores each node along with a list of its connected nodes, providing efficient iteration over neighbors. Adjacency matrix representation uses a two-dimensional array indicating edge presence between all node pairs, providing fast edge existence checks. Edge list representation maintains a simple list of all edges, useful for certain graph algorithms.

For distributed systems, graph partitioning techniques divide the graph across multiple processing arrangements. Vertex-cut partitioning assigns each vertex to one partition while edges may cross partitions. Edge-cut partitioning assigns each edge to one partition while vertices may be replicated across partitions. The choice of partitioning strategy affects query performance and storage requirements.

Cryptographic verification in the graph-based implementation uses hash values stored at nodes to verify capability claims. When an agent claims to possess a capability, the system verifies that a node with matching hash value exists in the graph and that the agent's identifier is associated with that node.

For relationship-based queries, the system can construct path hashes combining hash values of nodes along a relationship path. This path hash can be verified against stored anchor values to cryptographically confirm that a claimed relationship chain genuinely exists in the capability graph.

Optionally, the at least one autonomous agent is configured to execute a build executor module to compose each autonomous agent associated with the objective into a further autonomous agent. The term “build executor software module” as used herein refers to a component within the software framework that is specifically designed to handle the composition and execution of tasks within the distributed computer system. The build executor software module is responsible for composing each task associated with the objective in a specific order. Optionally, the build executor software module ensures that the tasks are organized and arranged according to a predefined sequence or priority.

Moreover, the build executor software module also composes each autonomous agent associated with the objective into a further autonomous agent. The further autonomous agent can be understood as a composite autonomous agent that combines the capabilities and functionalities of the individual associated with the objective. Furthermore, to maintain the security and integrity of the distributed computer system, the build executor software module encrypts access to the further autonomous agent. Optionally, by encrypting the access, it ensures that unauthorized entities cannot tamper with or manipulate the further autonomous agent. This security measure safeguards the execution of tasks and protects the distributed computer system from potential threats or unauthorized access. Optionally, the step of encrypting the access to the further autonomous agent need not necessarily be implemented in all embodiments of the present disclosure. In other words, such encryption may be performed only optionally.

Optionally, the composability of tasks is how the tasks are combined to fulfil a complex service request. Optionally, the further autonomous agent is a combination of two or more autonomous agents to perform complex action. Optionally, when an existing autonomous agent cannot be used to perform the task associated with the objective of service, a new agent is created. In the distributed computer system proposed, creation of new agent is validated by the Large Language Model (LLM) and/or ML models and the agents communicate within themselves using peer to peer encrypted communication. The plurality of autonomous agents participating in execution of tasks associated with the objective of the service request use encryption methods to communicate within themselves and other autonomous agent who are not participating in the tasks of the service request are blocked from communication to prevent any third-party access.

Optionally, the creation of new agent is treated as a block of a blockchain network, and after validation by the ML model and/or LLM and/or by existing agents using association with the task, each new agent created is appended to the chain of agents just like new block is connected to the existing blocks of a blockchain. Similar, to the blockchain network, once an agent has been created after validation, the distributed computer system may have the agent holding the transaction information such as metadata associated with the task. The technical effect of treating the agents as blocks of blockchain is that the proposed system provides a way such that tampering with the functioning of agent can be avoided as it is almost impossible to modify the block once the transaction has been validated. With such a distributed computer system, the service tasks are performed as planned and third-party attacks can be avoided. New agents created are cryptographically linked together just like blocks of a blockchain and are immutable, the functioning of agents cannot be altered. The distributed computer system provides a secure and transparent way to automatically execute the service request.

Optionally, the at least one autonomous agent is configured to execute a protocol generation module to generate at least one protocol specification for the execution of each task by the at least one autonomous agent associated with the task, and wherein the at least one protocol specification is generated using a domain-independent protocol specification language. The term “domain-independent protocol specification language” as used herein refers to a formal language that enables the definition of protocols for interactions across a plurality of problem domains. In this regard, the domain-independent protocol specification language is used to describe the format, structure, and rules for communication between at least one autonomous agent, and between the client-agent device and the at least one autonomous agent, regardless of the specific application domain or context. It will be appreciated that the domain-independent protocol specification language provides a standardized way of defining protocols that enables interoperability and seamless communication among the plurality of autonomous agents in the distributed computer system, regardless of the domain thereof. Moreover, the domain-independent protocol specification language in the software framework promotes fairness, transparency, and efficiency in the distributed computer system. Furthermore, the domain-independent protocol specification language enables the distributed computer system to become scalable for providing multi-domain services.

Optionally, the domain-independent protocol specification language is stored in a form of a set of instructions, in at least one memory device of the data communication network. Optionally, the at least one memory device may be a physical memory device, such as a hard drive or a flash drive, or a virtual memory device, such as a cloud-based server.

The term “protocol generation module” as used herein refers to a software tool that generates protocol(s) for the autonomous agents using the domain-independent protocol specification language. The term “protocol” as used herein refers to an implementation of the rules and guidelines described in a protocol specification. In other words, the at least one protocol is one of the critical building blocks and abstractions that define communications of the client-agent device. The at least one protocol of the client-agent device defines interactions of the client-agent device with other autonomous agents amongst the plurality of autonomous agents. Moreover, the at least one protocol defines how messages are encoded for a transportation thereof.

In this regard, when the at least one autonomous agent receives the task associated with the service request, the at least one autonomous agent leverages the protocol generation module. Moreover, the protocol generation module uses the domain-independent protocol specification language that is not restricted to any particular domain. Then, the protocol generation module generates the at least one protocol specification that outlines how the at least one autonomous agent should carry out the task. Optionally, the at least one protocol specification serves as a detailed roadmap, guiding the at least one autonomous agent through the execution of the task step by step.

Optionally, the further autonomous agent is configured to implement at least one protocol specification to fulfil the service request by the client agent device. In this regard, the further autonomous agent, which is a composite of the autonomous agent(s) associated with the objective, is configured to implement the at least one protocol specification generated by the distributed computer system. Moreover, the further autonomous agent executes the service request associated with the objective based on the defined protocol specification. Furthermore, the further autonomous agent automatically executes the service request, carrying out the necessary actions or operations to fulfil the service request.

Optionally, the list of associated agents corresponds to the autonomous agents that can be composed to fulfil the service request, or the list of autonomous agents that can work together to fulfil the service request or the list of autonomous agents whose functionalities need to be upgraded to fulfil the service request. In this regard, the system maintains the list of associated agents that contains information about various autonomous agents available in the system. Optionally, the list can be used to identify combinations of agents that can be composed to fulfill the service request. For example, if the service request involves complex tasks, the system can identify individual agents with complementary capabilities and compose them into a larger entity capable of handling the service request. Optionally, the list can facilitate collaboration among the autonomous agents. For example, if multiple autonomous agents have complementary skills, the multiple autonomous agents can work together to fulfill the service request more effectively than if each of the autonomous agent is operated in isolation.

Optionally, the list can help identify the autonomous agents whose functionalities may need to be upgraded to meet the requirements of the specific service request. For example, if the service request demands advanced capabilities that some autonomous agents lack, the system can identify such autonomous agents for potential upgrades. In another example, when the service request involves complex mathematical calculations. In such a case, the list reveals that some autonomous agents lack advanced mathematical capabilities. The system identifies the autonomous agents and schedules updates to enhance the mathematical processing abilities thereof, ensuring the autonomous agents can contribute effectively to future service requests.

Optionally, the autonomous agents whose functionalities need to be upgraded are restored back to original state using reverse operation of inverse bloom filter after fulfilment of the service request. In this regard, the system identifies the autonomous agents whose functionalities need to be upgraded based on the requirements of the service request. After the service request has been fulfilled and the autonomous agents have undergone upgrades, the system makes use of the reverse operation of the inverse bloom filter. It will be appreciated that the inverse bloom filter and its reversible properties allows for an efficient restoration process. Optionally, the inverse bloom filter ensures that the autonomous agents are reverted to their original state without excessive computational overhead. Optionally, the inverse bloom filter ensures that the autonomous agents are returned to their original state, with their initial functionalities intact and ready for new tasks. Optionally, the inverse bloom filter ensures that the autonomous agents can adapt to various service requests without accumulating a history of modifications that may not be relevant for future tasks.

In this regard, the invertible bloom filter uses a three-component data structure string a key, a value and a count. When a (key, value) pair needs to be stored, hashing operation is performed k times (depending upon the filter size) on the key to store the value in each of the location in the filter and the count is also incremented when the given value is stored at a location. Optionally, a reversible storage function is used for storing the value. In an example, the reversible storage function is a logical exclusive-OR (XOR) function. Optionally, an exclusive-OR (XOR) function is executed on the value for the reverse operation. Optionally, in such a case, for the value when performing an XOR with another value then performing an XOR operation a second time returns to the original value. The use of reversible storage function provides the discloses system a flexibility to restore the functionality of the autonomous agent. It will be appreciated that when all keys are distinct, the reverse operation enhances the efficiency of the system.

The present disclosure also relates to the method of operating the distributed computer system as described above. Various embodiments and variants disclosed above, with respect to the aforementioned the distributed computer system, apply mutatis mutandis to the method of operating the distributed computer system.

Optionally, the method further comprises executing a build executor module by the at least one autonomous agent to compose each autonomous agent associated with the objective into a further autonomous agent.

Optionally, the method further comprises executing a protocol generation module by the at least one autonomous agent to generate at least one protocol specification for the execution of each task by the at least one autonomous agent associated with the task, and wherein the at least one protocol specification is generated using a domain-independent protocol specification language.

Optionally, the method further comprises configuring the further autonomous agent to implement at least one protocol specification to fulfil the service request by the client agent device.

Optionally, the pre-processing operation includes multiple hashing of the tasks depending upon an invertible bloom filter size to generate the given proof value.

Optionally, the given proof value corresponds to the invertible bloom filter data elements for the task.

Optionally, the bloom tree is a tree structure where a node of the tree represents the invertible bloom filter data elements based on current functionality of the autonomous agent.

Optionally, the list of associated agents corresponds to the autonomous agents that can be composed to fulfil the service request, or the list of autonomous agents that can work together to fulfil the service request or the list of autonomous agents whose functionalities need to be upgraded to fulfil the service request.

Optionally, the autonomous agents whose functionalities need to be upgraded are restored back to original state using reverse operation of inverse bloom filter after fulfilment of the service request.

Optionally, the service request is received from at least one of: a software application executing on a device of a user, a software application executing on a computing device that is communicably coupled to a device of a user, a cloud-based software application, a digital twin of a user, a digital representation of a user, an artificial intelligence model (AI-model) based on a Large Language Model (LLM).

### DETAILED DESCRIPTION OF THE DRAWINGS

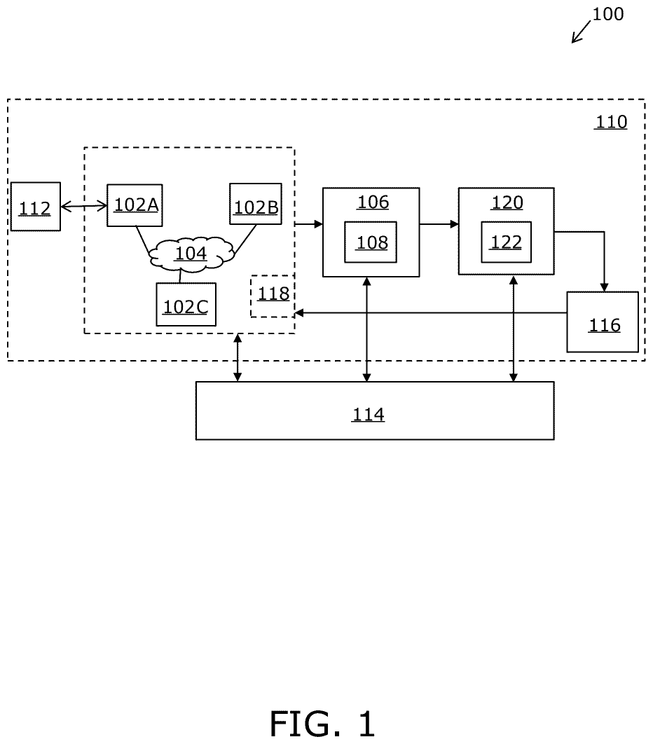

Referring to FIG. 1, illustrated is a distributed computer system 100, in accordance with an embodiment of the present disclosure. The distributed computer system 100 comprises a plurality of worker nodes 102A-C that are coupled together via a data communication network 104 to exchange data therebetween, wherein the plurality of worker nodes 102A-C include computing arrangements and local databases to process and store data therein, wherein the plurality of worker nodes 102A-C are plurality of autonomous agents (AAs), wherein the distributed computer system 100 is configured to use the plurality of worker nodes 102A-C for fulfilling a service request.

The distributed computer system 100 further comprises a processing arrangement 106 configured to generate a capability mapping structure 108 comprising one or more data elements, wherein each data element represents a functionality of an autonomous agent of the plurality of autonomous agents. The capability mapping structure 108 is configured to store cryptographic representations of agent functionalities in a space-efficient manner, enable deterministic or probabilistic lookup of agent capabilities, and perform cryptographic verification of agent functionality presence or absence. In the illustrated embodiment, the capability mapping structure 108 is implemented as a bloom tree combining invertible bloom filters with Merkle tree structure, though alternative implementations may employ other tree-based structures, probabilistic data structures, hash table-based structures, or graph-based structures as described herein.

The distributed computer system 100 comprises a software framework 110, wherein the software framework 110 comprises: a client-agent device 112 configured to receive the service request, to generate an objective associated with the service request and to send the objective to at least one autonomous agent. The distributed computer system 100 comprises at least one language model 114 comprised in the at least one of the autonomous agents configured to receive the objective from the at least one autonomous agent, to generate tasks related to the objective received from the at least one autonomous agent and to send the tasks to the at least one autonomous agent. The language model 114 may be implemented as a machine-learning model, large language model (LLM), transformer-based model, neural network model, or generative AI model as described herein.

The at least one autonomous agent is configured to execute a pre-processing operation to generate a plurality of proof values corresponding to the tasks using the capability mapping structure 108 and to send the plurality of proof values to the processing arrangement 106. The at least one autonomous agent is further configured to execute instructions to configure the processing arrangement 106 to identify a list of associated autonomous agents by mapping a given proof value to the capability mapping structure 108. The at least one autonomous agent receives from the processing arrangement 106 the list of associated autonomous agents, wherein the associated autonomous agents are configured to perform the tasks required to fulfil the service request by executing at least one action.

Optionally, the at least one autonomous agent is configured to execute a build executor module 116 to compose each autonomous agent associated with the objective into a further autonomous agent 118. Optionally, the at least one autonomous agent is configured to execute a protocol generation module 120 to generate at least one protocol specification 122 for the execution of each subtask by the at least one autonomous agent associated with the task, wherein the protocol specification is generated using the domain-independent protocol specification language. Optionally, the further autonomous agent 118 is configured to implement the at least one protocol specification 122 to fulfil the service request by the client-agent device 112.

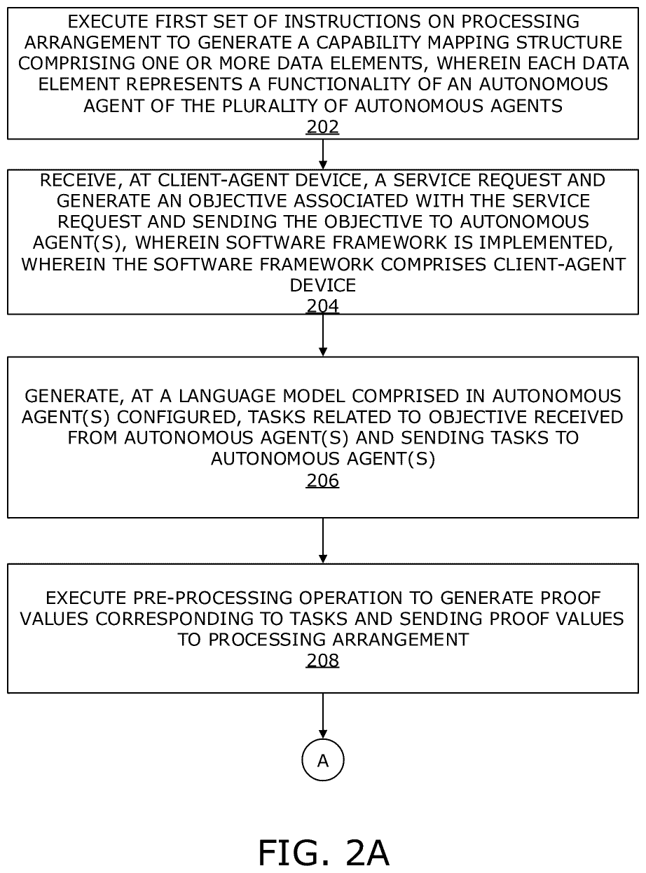

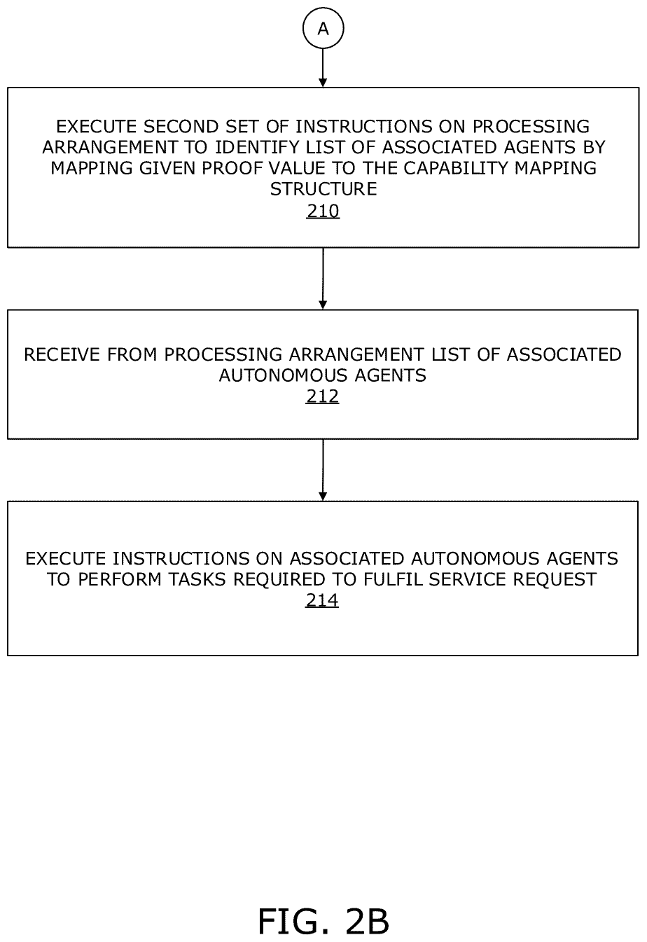

Referring to FIGS. 2A and 2B, illustrated is a flowchart illustrating steps of a method of operating a distributed computer system, in accordance with an embodiment of the present disclosure. The distributed computer system comprises a plurality of worker nodes that are coupled together via a data communication network to exchange data therebetween, wherein the worker nodes include computing arrangements and local databases to process and store data therein, wherein the plurality of worker nodes are plurality of autonomous agents (AAs), wherein the distributed computer system is configured to use the plurality of worker nodes for fulfilling a service request.

At step 202, there is executed a first set of instructions on a processing arrangement to generate a capability mapping structure comprising one or more data elements, wherein each data element represents a functionality of an autonomous agent of the plurality of autonomous agents. Generating the capability mapping structure comprises storing cryptographic representations of agent functionalities in a space-efficient manner, configuring the capability mapping structure to enable deterministic or probabilistic lookup of agent capabilities, and configuring the capability mapping structure to perform cryptographic verification of agent functionality presence or absence. In various implementations, the capability mapping structure may be a tree-based data structure (such as a bloom tree or Merkle tree), a probabilistic data structure (such as a cuckoo filter, count-min sketch, or quotient filter), a hash table-based data structure (such as a distributed hash table), or a graph-based data structure.

At step 204, there is received, at a client-agent device, the service request and generated an objective associated with the service request and sent the objective to an autonomous agent device, wherein a software framework is implemented, wherein the software framework comprises the client-agent device. At step 206, there is generated, at a language model comprised in at least one of the autonomous agents configured to generate tasks related to the objective received from the at least one autonomous agent and sending the tasks to the at least one autonomous agent. At step 208, there is executed, a pre-processing operation, using the at least one autonomous agent, to generate a plurality of proof values corresponding to tasks and sending the proof values to the processing arrangement. At step 210, there is executed, a second set of instructions, using the at least one autonomous agent, on the processing arrangement to identify a list of associated agents by mapping the proof value to the capability mapping structure. At step 212, there is received, using the at least one autonomous agent, from the processing arrangement the list of associated agents. At step 214, there is executed, the instructions on the associated agents to perform the tasks required to fulfil the service request.

The aforementioned steps are only illustrative, and other alternatives can also be provided where one or more steps are added, one or more steps are removed, or one or more steps are provided in a different sequence without departing from the scope of the claims herein.

1. A distributed computer system for managing and recording functionalities of a plurality of autonomous agents, the system comprising:
a plurality of worker nodes that are coupled together via a data communication network to exchange data therebetween, wherein the plurality of worker nodes include computing arrangements and local databases to process and store data therein, wherein the plurality of worker nodes are the plurality of autonomous agents (AAs), and wherein the distributed computer system is configured to use the plurality of worker nodes for fulfilling a service request;
a processing arrangement configured to generate a capability mapping structure comprising one or more data elements, wherein each data element represents a functionality of an autonomous agent of the plurality of autonomous agents, and wherein the capability mapping structure is configured to:
store cryptographic representations of agent functionalities in a space-efficient manner;
enable deterministic or probabilistic lookup of agent capabilities; and
perform cryptographic verification of agent functionality presence or absence; and
a software framework, wherein the software framework comprises:
a client-agent device configured to:
receive the service request;
generate an objective associated with the service request; and
send the objective to at least one autonomous agent of the plurality of autonomous agents, and
at least one language model comprised in the at least one of the autonomous agents of the plurality of autonomous agents, wherein the at least one language model is configured to:
receive the objective from the at least one autonomous agent of the plurality of autonomous agents;
generate tasks related to the objective received from the at least one autonomous agent of the plurality of autonomous agents; and
send the generated tasks to the at least one autonomous agent of the plurality of autonomous agents,
wherein the at least one autonomous agent of the plurality of autonomous agents is configured to:
execute a pre-processing operation to generate a plurality of proof values corresponding to the tasks using the capability mapping structure and to send the plurality of proof values to the processing arrangement;
execute instructions to configure the processing arrangement to identify a list of associated autonomous agents of the plurality of autonomous agents by mapping a given proof value to the capability mapping structure; and
receive from the processing arrangement the list of associated autonomous agents of the plurality of autonomous agents,
wherein the associated autonomous agents of the plurality of autonomous agents are configured to perform the tasks required to fulfill the service request by executing at least one action.

2. The distributed computer system of claim 1, wherein the capability mapping structure comprises a tree-based data structure comprising cryptographic hash values organized in a hierarchical arrangement.

3. The distributed computer system of claim 2, wherein the tree-based data structure is a bloom tree that combines invertible bloom filters with a Merkle tree structure.

4. The distributed computer system of claim 2, wherein the tree-based data structure is a Merkle tree comprising leaf nodes associated with functionality hashes and non-leaf nodes associated with hashes formed from child nodes.

5. The distributed computer system of claim 1, wherein the capability mapping structure comprises a probabilistic data structure comprising bit arrays configured for efficient capability representation and lookup.

6. The distributed computer system of claim 5, wherein the probabilistic data structure is selected from the group consisting of: a cuckoo filter, a count-min sketch, and a quotient filter.

7. The distributed computer system of claim 1, wherein the capability mapping structure comprises a hash table-based data structure comprising key-value pairs for capability lookup.

8. The distributed computer system of claim 7, wherein the hash table-based data structure is a distributed hash table implementing a consistent hashing protocol.

9. The distributed computer system of claim 1, wherein the capability mapping structure comprises a graph-based data structure comprising nodes representing agent capabilities and edges representing capability relationships.

10. The distributed computer system of claim 1, wherein the pre-processing operation comprises multiple hashing of the tasks based on a size parameter of the capability mapping structure to generate the given proof value.

11. The distributed computer system of claim 1, wherein the language model comprises at least one of: a large language model (LLM), a machine-learning model, a transformer-based model, a neural network model, or a generative AI model.

12. The distributed computer system of claim 1, wherein the capability mapping structure is operable to enable deterministic or probabilistic lookup of agent capabilities through hash-based query operations that return either deterministic matches that identify agents with exact capability correspondence or probabilistic match indications that provide likelihood estimates with a defined false positive rate.

13. The distributed computer system of claim 1, wherein the processing arrangement is operable to perform cryptographic verification of agent functionality presence or absence, and wherein to perform the cryptographic verification, the processing arrangement is configured to:
receive a proof value from the at least one autonomous agent;
execute hash comparison operations between the received proof value and stored cryptographic representations within the capability mapping structure; and
generate a verification result that indicates presence or absence of the functionality.

14. A method of operating a distributed computer system for managing and recording functionalities of a plurality of autonomous agents, the distributed computer system comprising a plurality of worker nodes that are coupled together via a data communication network to exchange data therebetween, wherein the plurality of worker nodes include computing arrangements and local databases to process and store data therein, wherein the plurality of worker nodes are the plurality of autonomous agents (AAs), and wherein the distributed computer system is configured to use the plurality of worker nodes for fulfilling a service request, the method comprising:
executing a first set of instructions on a processing arrangement to generate a capability mapping structure comprising one or more data elements, wherein each data element represents a functionality of an autonomous agent of the plurality of autonomous agents, wherein generating the capability mapping structure comprises:
storing cryptographic representations of agent functionalities in a space-efficient manner;
configuring the capability mapping structure to enable deterministic or probabilistic lookup of agent capabilities; and
configuring the capability mapping structure to perform cryptographic verification of agent functionality presence or absence;
receiving, at a client-agent device, the service request;
generating, by the client-agent device, an objective associated with the service request;
sending, by the client-agent device, the objective to at least one autonomous agent of the plurality of autonomous agents, wherein a software framework is implemented, wherein the software framework comprises the client-agent device;
receiving, at a language model comprised in the at least one of the autonomous agents of the plurality of autonomous agents, the objective from the at least one autonomous agent of the plurality of autonomous agents;
generating, by the language model, tasks related to the objective received from the at least one autonomous agent of the plurality of autonomous agents;
sending, by the language model, the generated tasks to the at least one autonomous agent of the plurality of autonomous agents;
executing, by the at least one autonomous agent of the plurality of autonomous agents, a pre-processing operation to generate a plurality of proof values corresponding to the tasks using the capability mapping structure;
sending, by the at least one autonomous agent, the plurality of proof values to the processing arrangement;
executing a second set of instructions on the processing arrangement to identify a list of associated agents of the plurality of autonomous agents by mapping a given proof value to the capability mapping structure;
receiving, at the at least one autonomous agent, from the processing arrangement, the list of associated autonomous agents of the plurality of autonomous agents; and
executing instructions on the associated autonomous agents of the plurality of autonomous agents to perform the tasks required to fulfill the service request by executing at least one action.

15. The method of claim 14, wherein the capability mapping structure comprises a tree-based data structure comprising cryptographic hash values organized in a hierarchical arrangement.

16. The method of claim 15, wherein the tree-based data structure is a bloom tree that combines invertible bloom filters with a Merkle tree structure.

17. The method of claim 14, wherein the capability mapping structure comprises a probabilistic data structure comprising bit arrays configured for efficient capability representation and lookup.

18. The method of claim 14, wherein the language model comprises at least one of: a large language model (LLM), a machine-learning model, a transformer-based model, a neural network model, or a generative AI model.

19. The method of claim 14, wherein enabling deterministic or probabilistic lookup of agent capabilities comprises: executing hash-based query operations that return either deterministic matches identifying agents with exact capability correspondence or probabilistic match indications providing likelihood estimates with a defined false positive rate.

20. The method of claim 14, wherein performing cryptographic verification of agent functionality presence or absence comprises: receiving a proof value from the at least one autonomous agent, executing hash comparison operations between the received proof value and stored cryptographic representations within the capability mapping structure, and generating a verification result indicating presence or absence of the functionality.
